(19) United States
(12) Patent Application Publication
(10) Pub. No.: US 2016/0063656 A1
(43) Pub. Date: Mar. 3, 2016

(54) SYLLABUS AUTHORING USING DATA INTEGRATION

(71) Applicant: Apollo Education Group, Inc., Phonenix, AZ (US)

(72) Inventors: Narender Vattikonda, San Jose, CA (US); Shridhar Navanageri, Sunnyvale, CA (US); Sudhakar Subashchandrabose, San Jose, CA (US); Raghavendra Reddy, Sunnyvale, CA (US); Anil Maipady, San Jose, CA (US)

(21) Appl. No.: 14/473,526

(22) Filed: Aug. 29, 2014

(51) Int. Cl. G06Q 50/20; G06Q 10/00

(52) U.S. Cl. CPC G06Q 50/205; G06Q 10/00

(57) ABSTRACT

Techniques are described for a syllabus authoring and publishing system that allows educators to create and customize syllabi using data integration to optimize for various criteria. A syllabus begins with one or more course objectives, wherein one or more data services are consulted for optimal selection of course activities to satisfy the course objectives. After the appropriate course activities are selected and customized, the syllabus may be saved as one of several syllabus versions and a particular version may be published downstream for further customization by other users. The syllabus is a dynamic document with rich metadata and may directly link to and launch interactive learning objects. The metadata may also specify user role based and workflow context based permissions for viewing, editing, and interacting with the syllabus. All changes and interactions with the syllabus may be tracked in the metadata for analytics and other uses.

### FIELD OF THE INVENTION

The present invention relates to educational course planning, and, more specifically, to improved syllabus authoring using data integration.

### BACKGROUND

A syllabus is an essential planning guide for any educational course. By providing a detailed roadmap for the learning goals, hands-on activities, and study materials to be used during the course, both the educator and the student can plan their lessons and studies accordingly. A well-organized syllabus that is constantly updated with the most relevant materials helps students to focus on the most appropriate skillsets for their chosen field, facilitating educational success and professional career growth.

Syllabus creation is typically a manual process of limited scope and flexibility. In one approach, an educator may use a template syllabus or an older syllabus for a course, performing minor edits in a word processor to update the course syllabus for a current class period. The syllabus is then distributed to the students as a static word processing document. However, this approach may tend to perpetuate the use of less effective teaching methods and/or outdated study materials while overlooking opportunities to integrate new, more suitable teaching methods, materials, and activities. Furthermore, the static and unmanaged handling of the syllabus as a word processing document renders it difficult for educators and administrators to appreciate the positive or negative impact of different changes to the syllabus.

Therefore, it would be beneficial to provide an improved method of authoring a syllabus that addresses the needs of students and educators.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for improved syllabus authoring using data integration, according to an embodiment.

FIG. 2 is a block diagram that depicts example syllabus authoring workflows, according to an embodiment.

FIG. 3A is a flow diagram that depicts a process for improved syllabus authoring using data integration, according to an embodiment.

FIG. 3B is a flow diagram that depicts a process for updating a syllabus with data integration, according to an embodiment.

FIG. 4A is a block diagram that depicts an example user interface for syllabus authoring, according to an embodiment.

FIG. 4B is a block diagram that depicts course activities being populated for an objective in a syllabus, according to an embodiment.

FIG. 5 is a block diagram that depicts an example user interface for interacting with a syllabus, according to an embodiment.

FIG. 6 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A syllabus authoring and publishing system allows educators to create and customize syllabi using data integration to optimize for various criteria. In one embodiment, a new draft syllabus begins with one or more objectives for a particular course offering, which may be defined by an Instructional Design and Development (IDD) team and/or transcribed from an existing syllabus. One or more data services are consulted for optimal selection of course activities to satisfy the course objectives. After the appropriate course activities are selected, the draft syllabus may be saved as one of several syllabus versions and a particular version may be selected for publishing downstream to faculty.

For a given course offering, faculty that are not yet assigned to teach the given course offering can make customizations to the published version to create a faculty template. Faculty that are assigned to teach the given course offering can make their own customizations on top of the faculty template to create the final course offering syllabus. The syllabus customizations can be made according to teaching experience, preferences, the particular needs of a given course offering, and the data services as described above. In some embodiments, the IDD team or the assigned faculty may create and publish the syllabus directly to students. The syllabus may be updated for new class periods by customizing in a similar manner to integrate the latest and most effective teaching activities and materials.

In an embodiment, the data services utilized by the syllabus authoring and publishing system may include: 1) a student profile service to analyze the teaching effectiveness of different activities with historical class data and individual student profiles, 2) a learning activity service and a learning activity rating service to maintain and search a learning activity repository for the most effective or highest rated activities for a particular objective, 3) a subject matter expert (SME) service to determine, based on current research, whether newer activities or materials may be more effective to teach a particular objective, 4) an accreditation service to ensure that the syllabus adheres to the requirements of one or more accreditation agencies, and 5) a student career service to ensure that the chosen activities are also relevant for professional career success.

The syllabus is a dynamic document with rich metadata and may directly link to and launch interactive learning objects such as tutors, labs, quizzes and tests, reference materials, and other resources, which are further customizable with various parameters. The metadata may also specify permissions for viewing, editing, and interacting with the syllabus and its linked learning objects, which may depend on the workflow context of the syllabus and/or the role of the user accessing the syllabus. All authoring changes and interactions with the syllabus and their resulting impacts may be tracked in the metadata, enabling data mining for presentation rendering, analytics, computational logic, provisioning, and other tasks.

System Overview for Syllabus Authoring using Data Integration

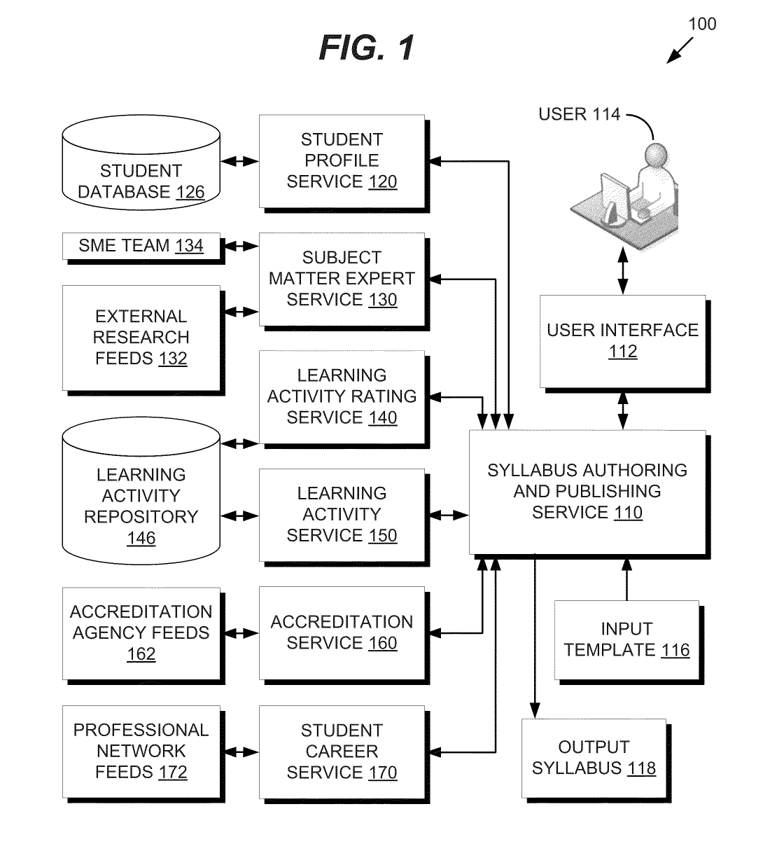

FIG. 1 is a block diagram that depicts an example system for improved syllabus authoring using data integration, according to an embodiment. System 100 of FIG. 1 includes syllabus authoring and publishing service 110, user interface 112, user 114, input template 116, output syllabus 118, student profile service 120, student database 126, subject matter expert (SME) service 130, external research feeds 132, SME team 134, learning activity rating service 140, learning activity repository 146, learning activity service 150, accreditation service 160, accreditation agency feeds 162, student career service 170, and professional network feeds 172.

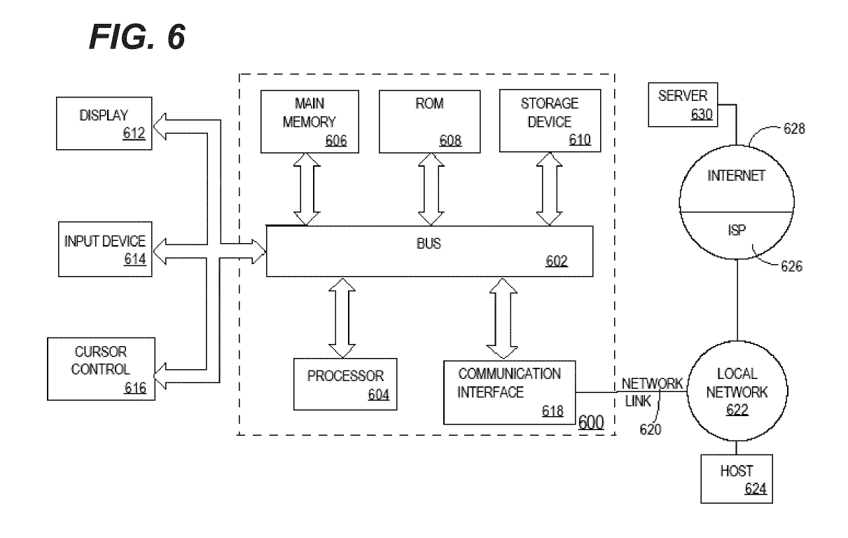

In one example syllabus authoring workflow, the authoring process begins in a Course Design Guide (CDG) context, where user 114 corresponds to the IDD team or another expert who creates a broad CDG template syllabus that may be further customized by faculty downstream. User 114 may interface with syllabus authoring and publishing service 110 via user interface 112, which may show a graphical user interface (GUI). Syllabus authoring and publishing service 110 may execute on a server corresponding to computer system 600 as described in conjunction with FIG. 6 below. User 114 begins with input template 116, which may correspond to a new, blank syllabus. Alternatively, input template 116 may be transcribed from an existing syllabus. User 114 may add one or more objectives to input template 116, which may already include some existing objectives if transcribed from an existing syllabus. In some embodiments, the objectives may be determined and added automatically, for example by examining syllabi from prior or similar course offerings.

The objectives in input template 116 correspond to goals that should be met after the successful completion of a particular course offering that the syllabus is directed towards. For example, for an intermediate level computer science course, one of the objectives may be “intermediate level mastery of multi-threaded programming”. Another objective may be “capable of writing a recursive function in assembly or machine language”. Thus, syllabus objectives may be described broadly or narrowly to describe target skill levels and subject matter to be mastered.

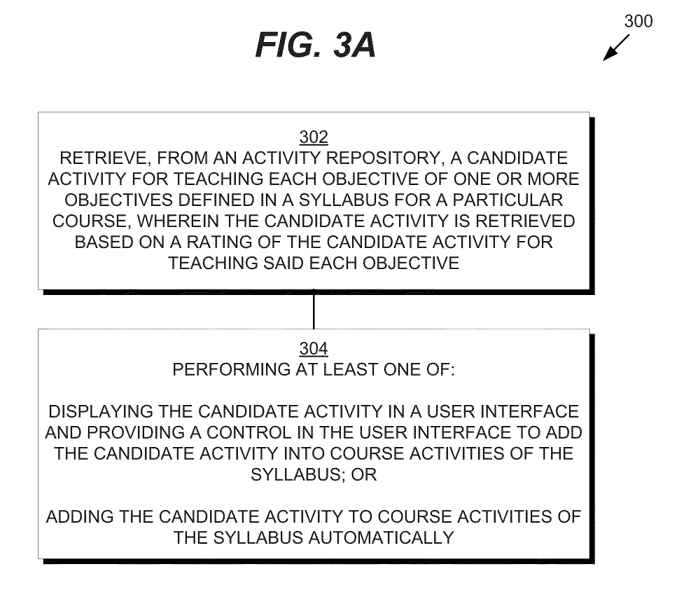

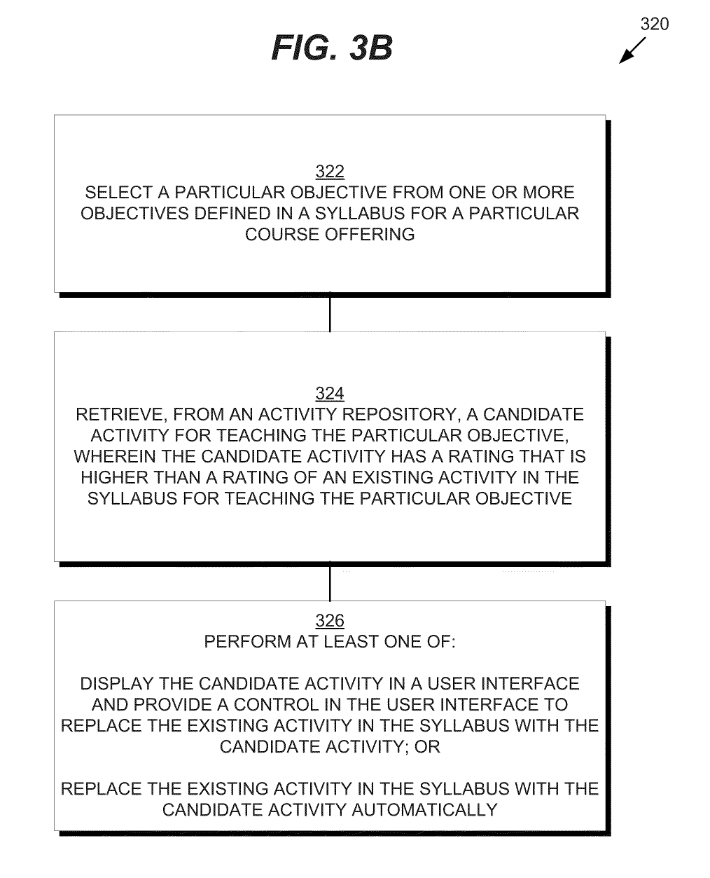

To populate the syllabus with corresponding activities to achieve the one or more objectives, one or more data services may be consulted, as represented by student profile service 120, subject matter expert service 130, learning activity rating service 140, learning activity service 150, accreditation service 160, and student career service 170 in FIG. 1. These data services may be hardware or software implemented services on a server or another computing device, such as computer system 600 as described in conjunction with FIG. 6 below. Further, these data services may consult various databases, repositories, external data feeds, expert teams, and other data sources, as represented by student database 126, external research feeds 132, SME team 134, learning activity repository 146, accreditation agency feeds 162, and professional network feeds 172 in FIG. 1. By utilizing these services, syllabus authoring and publishing service 110 can recommend the most effective activities for teaching the objectives in input template 116, which user 114 may optionally modify based on her teaching experience and preferences. These activities may be organized into a schedule and may reference and execute various learning objects including tutors, labs, quizzes and tests, reference materials, and other resources. A more detailed description of this activity selection process is provided below in conjunction with FIG. 3A.

Once user 114 is satisfied with the chosen activities, the resulting syllabus may be saved as output syllabus 118, which may be one of many different syllabus versions. User 114 may compare the different syllabus versions and choose one for publishing, making output syllabus 118 available to a specified downstream party. For example, output syllabus 118 may be published to one or more faculty members for further customization, thereby transitioning from the CDG context to the faculty template context in the syllabus authoring workflow. The faculty template context may proceed similarly to the CDG context, wherein user 114 corresponds to an unassigned faculty member and input template 116 corresponds to the published output syllabus 118 from the previous CDG context. Optionally or alternatively, the publishing may make output syllabus 118 available for read-only viewing by students. Students can therefore preview the syllabus for the course offering before deciding to enroll, or to gather the necessary reference materials before class begins, even if faculty is not yet assigned to the particular course offering.

Metadata in the syllabus may specify permissions and privileges depending on the role of the user and the current workflow context of the syllabus. For example, during a CDG context, the IDD team may have unrestricted syllabus editing privileges and may further lock certain objectives and/or activities from being modified. Once the syllabus is published to unassigned faculty or faculty not assigned to the particular course offering, thereby transitioning the workflow context to a faculty template context, privileges may be limited to only modifying objectives and activities that are not locked. Further, as discussed above, students may optionally be provided read-only access to the syllabus. After the syllabus is published to a specific faculty member assigned to teach a specific course offering, transitioning the workflow context to a course offering context, the specific faculty member may further customize the syllabus and publish the finished syllabus for interactive use by enrolled students. After time passes and a new teaching period begins, the syllabus may be customized as necessary to refresh the syllabus with the latest and most effective teaching activities and materials.

### Syllabus Authoring Workflows

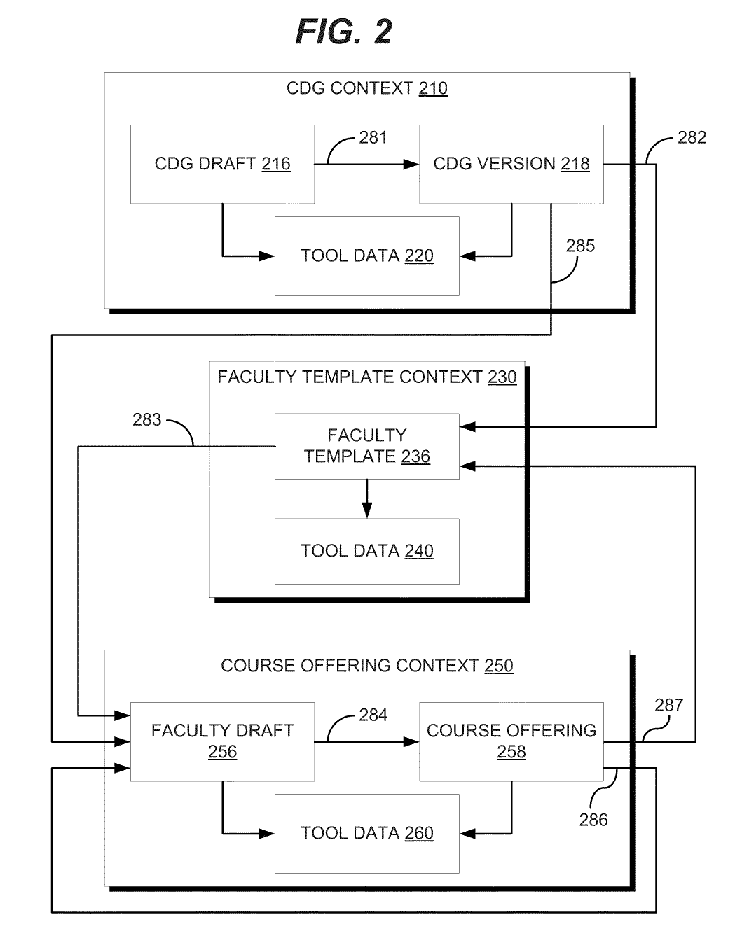

In FIG. 1, a syllabus authoring workflow was described that started from a CDG context, transitioning to a faculty template context and then to a course offering context. However, many other syllabus authoring workflows are also possible. FIG. 2 is a block diagram that depicts example syllabus authoring workflows, according to an embodiment. FIG. 2 includes CDG context 210, faculty template context 230, course offering context 250, and previously customized syllabus 278. CDG context 210 includes CDG draft 216, CDG version 218, and tool data 220. Faculty template context 230 includes faculty template 236 and tool data 240. Course offering context 250 includes faculty draft 256, course offering 258, and tool data 260. Flow 281, flow 282, flow 283, flow 284, flow 285, flow 286, and flow 287 describe transitions of a syllabus within a workflow context or between different workflow contexts.

To review the process described above in conjunction with FIG. 1, an IDD team in CDG context 210 begins with CDG draft 216 for teaching a particular course offering, corresponding to input template 116 in FIG. 1. By populating and customizing CDG draft 216 with various objectives and activities in flow 281, CDG draft 216 becomes CDG version 218, or one particular version of the CDG syllabus, corresponding to output syllabus 118 in FIG. 1. As discussed above, certain objectives or activities in CDG version 218 may be locked by the IDD team to prevent modification by users in other contexts. Tool data 220 may contain the various learning objects that are referenced and linked from CDG draft 216 and CDG version 218. While only a single CDG version 218 is shown in FIG. 2, multiple candidate versions can be developed and compared, allowing the IDD team to choose a particular version for publishing. Once a particular CDG version 218 is selected, it can be published for customization by unassigned faculty in flow 282, or for customization by faculty assigned to teach the particular course offering in flow 285.

Turning to faculty template context 230, an unassigned faculty member begins with faculty template 236, which may correspond to CDG version 218 provided from flow 282. Alternatively, the unassigned faculty member may instead start from course offering 258, which is transcribed during flow 287. For example, the unassigned faculty member may already have extensive experience teaching the particular course offering, in which case the unassigned faculty member may already have a previously customized syllabus from a prior teaching period, represented by course offering 258 in FIG. 2. Thus, depending on the source of faculty template 236, tool data 240 contains learning objects copied from or referencing tool data 220 or tool data 260. The unassigned faculty member may then customize faculty template 236, subject to the locks that may have been put in place by the IDD team. Once faculty template 236 is customized to the unassigned faculty member's satisfaction, it can then be published to a faculty member that is assigned to teach the particular course offering in flow 283.

Turning to course offering context 250, a faculty member assigned to teach the particular course offering begins with faculty draft 256, which may be transcribed from faculty template 236 in flow 283. However, as shown in flow 285, faculty draft 256 may also be transcribed directly from CDG version 218, bypassing the intermediate faculty template step. Alternatively, as indicated in flow 286, faculty draft 256 may be transcribed from a previously customized syllabus from a prior teaching period, represented by course offering 258 in FIG. 2. Thus, depending on the source of faculty draft 256, tool data 260 contains learning objects copied from or referencing tool data 220 or tool data 240. The assigned faculty member may then customize faculty draft 256, also subject to the locks that may have been put in place by the IDD team. Once faculty draft 256 is customized to the assigned faculty member's satisfaction, it can then be published as a final syllabus in flow 284, or course offering 258, ready for interactive use by students enrolled in the particular course offering.

While the workflow contexts illustrated in FIG. 2 are based on an organizational hierarchy of IDD teams, unassigned faculty and assigned faculty, corresponding respectively to CDG context 210, faculty template context 230, and course offering context 250, any suitable workflow contexts may be specified in metadata contained in the syllabus or otherwise available to syllabus authoring and publishing service 110. Further, the flow processes for transitioning the syllabus within a context or between contexts can be specified and customized in the metadata as well. Syllabus authoring and publishing service 110 can thus be tailored according to the evolving workflow and organizational needs of an educational institution by adjusting the metadata accordingly.

Syllabus Authoring Process with Data Integration

With an outline of system 100 and the various possible authoring workflows now in place, it may be instructive to review a process to create a syllabus with data integration. Turning to FIG. 3A, FIG. 3A is a flow diagram that depicts a process for improved syllabus authoring using data integration, according to an embodiment.

At block 302 of process 300, referring to FIG. 1, syllabus authoring and publishing service 110 retrieves a candidate activity from learning activity repository 146 for teaching each objective of one or more objectives defined in input template 116 for a particular course. As shown in FIG. 1, syllabus authoring and publishing service 110 may retrieve the candidate activity using learning activity rating service 140, which selects the candidate activity based on a rating or effectiveness for teaching each objective.

The rating utilized by learning activity rating service 140 may be based on many factors including information retrieved from other data services such as student profile service 120, subject matter expert service 130, and student career service 170. For example, student profile service 120 may examine historical student performance individually and in groups, such as classes or years, within student database 126 to glean student achievement information such as test performance, earned awards and certifications, subject matter retention, and other data in relation to a given activity. Activities associated with higher student achievement may be assigned a higher rating. Student database 126 may also include feedback and surveys from both students and instructors, which may also be integrated into the rating.

Subject matter expert service 130 may determine the relevance of activities, for example by using an automated search engine to research the current state of the art from external research feeds 132, as discussed in further detail below. This search may be optionally assisted from manual input provided by SME team 134. Activities associated with a higher relevance may be assigned a higher rating.

Student career service 170 may rate activities according to relevance within professional contexts. For example, the employment status of graduates and the skills demanded by employers may be tracked from professional network feeds 172. Activities associated with greater professional relevance may be assigned a higher rating.

### Syllabus Authoring User Interface

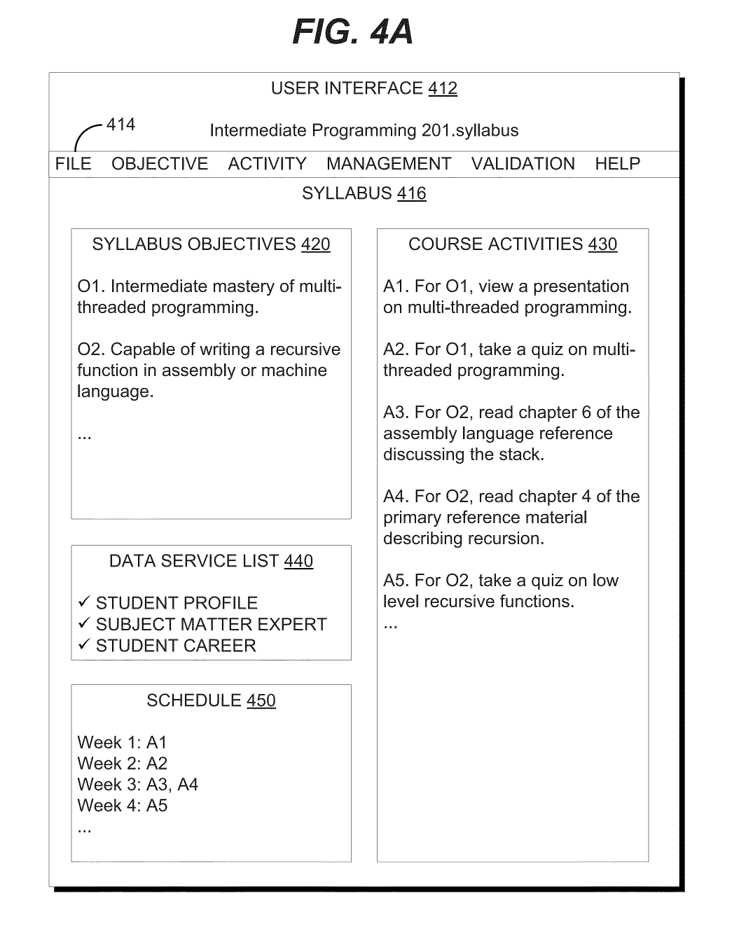

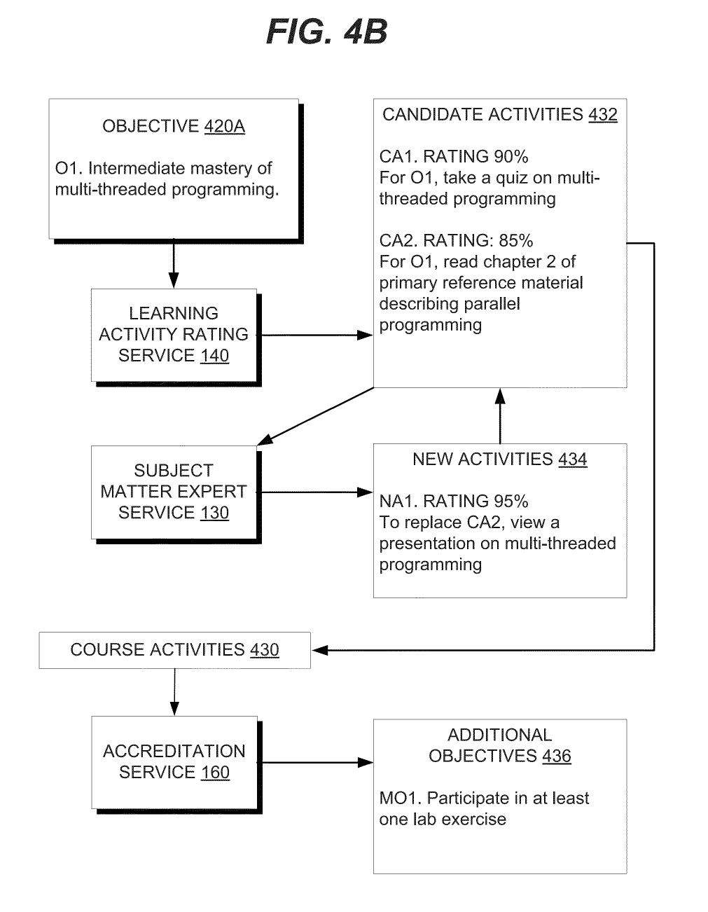

To better visualize the syllabus authoring process, it may be helpful to see an example of an authoring user interface. FIG. 4A is a block diagram that depicts an example user interface for syllabus authoring, according to an embodiment. FIG. 4A includes user interface 412. User interface 412 includes toolbar 414 and syllabus 416. Syllabus 416 includes syllabus objectives 420, course activities 430, data service list 440, and schedule 450. With respect to FIG. 4A, user interface 412 may correspond to user interface 112 from FIG. 1, and syllabus 416 may correspond to input template 116 from FIG. 1.

Syllabus 416 may correspond to a new syllabus with objectives specified by the IDD team, a new syllabus with automatically selected objectives, or a syllabus with objectives and associated activities transcribed from an existing syllabus, as described above. Referring to FIG. 2, syllabus 416 may correspond to CDG draft 216, faculty template 236, or faculty draft 256, depending on the particular workflow context. For the purposes of example, it may be assumed that syllabus 416 corresponds to CDG draft 216.

As shown in user interface 412, syllabus 416 may be directed to the specific course offering “Intermediate Programming 201”. Accordingly, syllabus objectives 420 include one or more objectives that should be achieved when a student successfully completes the “Intermediate Programming 201” course. Using the same example as described previously in conjunction with FIG. 1, syllabus objectives 420 include objective O1, or “Intermediate mastery of multi-threaded programming”, and objective O2, or “Capable of writing a recursive function in assembly or machine language”. Additional objectives may be included in syllabus objectives 420 that are not specifically shown in FIG. 4A.

Using the example data shown in syllabus 416 for block 302, each of the objectives in syllabus objectives 420 is queried using learning activity rating service 140 in FIG. 1 to retrieve a candidate activity from learning activity repository 146. The candidate activity is the highest ranked activity for effectively teaching the queried objective. Note that while process 300 only describes retrieving a single candidate activity for each objective, embodiments may also retrieve multiple activities for each objective.

As discussed above, the rating for each candidate activity may be based on multiple factors. In the example user interface 412 shown in FIG. 4A, the data sources for these factors are indicated within data service list 440. Thus, referring to FIG. 1, the rating for each candidate activity may be based on information previously gleaned from student profile service 120, subject matter expert service 130, and student career service 170.

While data service list 440 is shown as a simple unordered list of data services, embodiments may present user interfaces allowing data services to be weighed in importance or ordered by priority, and for each data service to be divided into more granular factors. For example, student profile service 120 may be defined as 50% of the rating, subject matter expert service 130 may be defined as 30% of the rating, and student career service 170 may be defined as 20% of the rating. Further, student profile service 120 may be divided into several contributing granular factors, for example wherein test performance is weighed more heavily than student feedback.

Populating a Syllabus with Activities

Returning again to block 302, using objective O1 from syllabus objectives 420 as an example, candidate activities for achieving objective O1 may be retrieved from learning activity rating service 140. To visualize this process, FIG. 4B is a block diagram that depicts course activities being populated for an objective in a syllabus, according to an embodiment. FIG. 4B includes subject matter expert service 130, learning activity rating service 140, accreditation service 160, objective 420A, course activities 430, candidate activities 432, new activities 434, and additional objectives 436. With respect to FIG. 4B, like numbered elements may correspond to like numbered elements from FIG. 1 and FIG. 4A.

As shown in FIG. 4B, objective 420A corresponds to objective O1 from syllabus objectives 420 in FIG. 4A. Objective 420A is queried against learning activity rating service 140, which proceeds to search learning activity repository 146 for suitable candidate activities. The candidate activities are retrieved in descending rank order and only the highest ranking candidate activities 432 are returned. As shown in candidate activities 432, these activities include CA1, with a rating of 90%, “For O1, take a quiz on multi-threaded programming”, and CA2, with a rating of 85%, “For O1, read chapter 2 of primary reference material describing parallel programming”.

While the activities identified in candidate activities 432 may represent the highest rated activities available from learning activity repository 146, it is possible that the activities may become less relevant over time, particularly for fast changing and evolving subject matter such as computer science. Thus, referring to FIG. 1 and FIG. 4B, syllabus authoring and publishing service 110 may consult with subject matter expert service 130 to determine, based on current research, whether a new activity is rated higher than a candidate activity in candidate activities 432 for teaching objective 420A. If so determined, the new activity replaces the candidate activity and is passed to learning activity service 150 for adding into learning activity repository 146.

In the example shown in FIG. 4B, subject matter expert service 130 does determine that a new activity NA1 in new activities 434 has a higher 95% rating when compared to candidate activity CA2, which only has a rating of 85%. Referring to FIG. 1, subject matter expert service 130 can utilize external research feeds 132 and/or SME team 134 to make this determination. This determination can be made automatically if SME team 314 is not utilized. External research feeds 132 may include many different data sources including outside databases, scholarly articles and whitepapers, research from other educational institutions, or the Internet generally. For example, sources from external research feeds 132 may indicate that multi-threaded programming is difficult to learn by reading a conventional textbook, and that a more visual presentation-based approach leads to better student comprehension. Accordingly, the new presentation-based activity NA1 is assigned a higher 95% rating compared to the traditional textbook based activity CA2 with a rating of 85%. Thus, the new activity NA1 replaces CA2 in candidate activities 432, and the new activity NA1 is also passed to learning activity service 150 for adding into learning activity repository 146 in FIG. 1.

In an embodiment, subject matter expert service 130 may utilize a search engine to search external research feeds 132 for the highest ranked or most relevant activities to teach objective 420A. The search engine ranking may be based on the same factors used by learning activity rating service 140 for rating existing activities in learning activity repository 146. However, since new activities retrieved from external research feeds 132 may not yet have any associated data available from student database 126 or professional network feeds 172, the search engine ranking may be based on alternative or additional criteria such as favoring more recently established activities, activities with higher popularity or greater number of citations, activities endorsed by noted experts or researchers in the field, and/or activities with greater relevance and favor in the academic and professional community.

At block 304 of process 300, referring to FIG. 1 and FIG. 4A, syllabus authoring and publishing service 110 performs at least one of: displaying the candidate activity in a user interface and providing a control in the user interface to add the candidate activity into course activities 430 of syllabus 416, or adding the candidate activity into course activities 430 of syllabus 416 automatically. Referring to FIG. 4B, for objective O1 or objective 420A in particular, the associated candidate activities are listed in candidate activities 432. However, candidate activity CA2 was previously replaced with new activity NA1. Thus, candidate activity CA1 and new activity NA1 are added to course activities 430. Referring to FIG. 4A, it can be seen that course activities 430 now includes activity A1 corresponding to NA1, and activity A2 corresponding to CA1. Thus, in the example shown in FIG. 4A, the candidate activity is automatically added to course activities 430. However, in alternative embodiments, user interface 412 may display a dialog showing the candidate activity or candidate activities as highly rated or recommended activities, and provide a control for the user to manually add the recommended activities into course activities 430.

Thus, process 300 is complete for objective O1. Process 300 may also be carried out for the other objectives in syllabus objectives 420 to finish populating course activities 430 of syllabus 416. Thus, as shown in course activities 430, three activities A3, A4, and A5 are added to teach objective O2. Additional course activities may also be added for other objectives in syllabus objectives 420 that are not specifically shown in FIG. 4A. After fully populating course activities 430, schedule 450 may be developed with activities carried out during particular time periods, as shown. The schedule may be developed automatically according to subject matter prerequisites, subject matter complexity or difficulty, grouping of related concepts, and other criteria. While schedule 450 is shown as a weekly schedule, embodiments may use any time period granularity as desired.

Note that while syllabus authoring and publishing service 110 attempts to recommend the most effective course activities 430 as discussed above, user 114 may still customize syllabus 416 according to her teaching experience, preferences, and the particular needs of the course. Thus, by using toolbar 414 or other interface widgets, user 114 can manually specify or override particular syllabus objectives 420 and/or course activities 430 for syllabus 416, or rearrange schedule 450 as desired.

Updating an Existing Syllabus with Higher Rated Activities

In the case where syllabus 416 is copied from an existing syllabus, then course activities 430 may already include some existing activities in association with syllabus objectives 420. In this case, the syllabus authoring workflow should examine whether the existing activities are still relevant, and if not, update the existing activities with more effective teaching activities. For example, the ratings of the activities within learning activity repository 146 may change over time, and new activities may become available from external research feeds 132 that would be advantageous to include. To integrate these changes, process 320 in FIG. 3B may be carried out.

FIG. 3B is a flow diagram that depicts a process for updating a syllabus with data integration, according to an embodiment. At block 322 of process 320, referring to FIG. 1 and FIG. 4A, syllabus authoring and publishing service 110 selects a particular objective from syllabus objectives 420 defined in syllabus 416 for the intermediate programming 201 course offering. For example, objective O1 may be selected. In the case where all of existing activities for all the objectives are to be examined, then process 320 may be repeated by iterating through all of the objectives in syllabus objectives 420.

At block 324 of process 320, referring to FIG. 1 and FIG. 4A, syllabus authoring and publishing service 110 retrieves, from learning activity repository 146, a candidate activity for teaching objective O1, wherein the candidate activity has a rating that is higher than a rating of an existing activity in syllabus 416 for teaching objective O1. For example, assume that activity A2 already exists in syllabus 416, and is assigned a rating of 90% as discussed above. However, based on updates to the ratings in learning activity repository 146, a candidate activity CA3 may be retrieved in block 324, wherein candidate activity CA3 is assigned a higher rating of 95% for teaching objective O1. Optionally, subject matter expert service 130 may be consulted to determine whether a new activity with an even higher rating can replace candidate activity CA3.

At block 326 of process 320, referring to FIG. 1 and FIG. 4A, syllabus authoring and publishing service 110 performs at least one of: displaying the candidate activity CA3 in user interface 412 and provide a control in user interface 412 to replace activity A2 in syllabus 416 with candidate activity CA3, or replace activity A2 in syllabus 416 with candidate activity CA3 automatically. For example, user interface 412 may display a dialog showing candidate activity CA3 as a highly rated or recommended activity, and provide a control for the user to manually replace activity A2 with candidate activity CA3. In other embodiments, this replacement may occur automatically without any user prompt. Accordingly, process 320 may be used to refresh an existing syllabus for a new class period, preventing the propagation of stale activities by replacing those stale existing activities with more effective activities, as appropriate.

### Syllabus Validation

After populating course activities 430, user 114 may select the validation function in toolbar 414 to validate course activities 430 according to various criteria. For example, it may be important to ensure that course activities 430 complies with various requirements imposed by one or more professional and/or educational accreditation agencies. Accordingly, as shown in FIG. 4B, course activities 430 may be provided to accreditation service 160 to verify against one or more accreditation agency requirements. In one embodiment, this occurs automatically, with accreditation service 160 receiving requirements from accreditation agency feeds 162. In another embodiment, accreditation service 160 may correspond to review committee that conducts a manual review. If accreditation service 160 finds any problems with course activities 430, a list of additional objectives may be returned to satisfy any missing accreditation agency requirements.

As shown in FIG. 4B, this list of additional objectives corresponds to additional objectives 436, which includes objective MO1, “Participate in at least one lab exercise”. Accordingly, to meet accreditation requirements, additional objectives 436 may be appended to syllabus objectives 420, and process 300 may be carried out again for additional objectives 436. For example, an activity A6 may be appended to course activities 430, corresponding to “A6. For O1, perform a lab exercise for multi-threaded programming”.

### Interactve Syllabus User Interface and Metadata

As discussed above, several authoring workflow processes are possible, in which case syllabus 416 may be published downstream for customization by other users such as assigned faculty before course starts and assigned faculty after course starts. Syllabus 416 may published for use by enrolled students after assigned faculty complete their final customizations. Accordingly, the student as user 114 may view and interact with the published syllabus 416 by utilizing user interface 112.

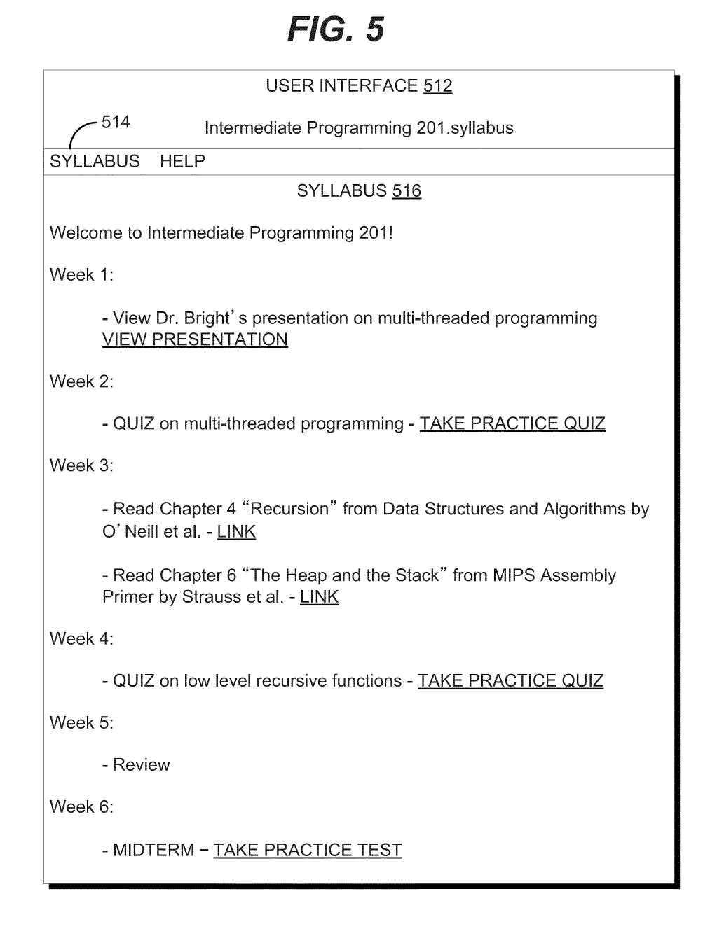

As described above, the syllabus is a dynamic document with rich metadata to view and launch various learning objects. FIG. 5 is a block diagram that depicts an example user interface for interacting with a syllabus, according to an embodiment. User interface 512 of FIG. 5 includes toolbar 514 and syllabus 516. With respect to FIG. 5, user interface 512 may correspond to user interface 112 of FIG. 1, and syllabus 516 may correspond to syllabus 416 of FIG. 4A and course offering 258 in FIG. 2.

As shown in syllabus 516, the course activities 430 are organized according to schedule 450, presented to user 114 in user interface 512. In an embodiment, each of course activities 430 may be referenced within syllabus 516 by linking to the corresponding activity in learning activity repository 146. These references may be represented by metadata in syllabus 516, wherein the metadata associates activities from learning activity repository 146 to specific learning objects in tool data 260. Thus, the metadata acts as a wrapper of parameters around content stored in tool data 260.

As shown in FIG. 5, toolbar 514 is limited to only the “SYLLABUS” and “HELP” functions when user 114 is a student. Thus, metadata in syllabus 516 may specify that students have no syllabus editing privileges. However, the metadata may also specify that students can interact with the various learning objects linked within syllabus 516, which may be stored in accompanying tool data such as tool data 260 in FIG. 2. For example, in week 1, the student may click on the “VIEW PRESENTATION” link to view the presentation, or the “LINK”s to the reference materials in week 3 to jump to the relevant chapters in an electronic copy, to bookmark the chapters on a secondary device such as a tablet or e-reader, or to access a storefront to purchase the reference materials.

Additionally, the user may take practice quizzes and tests by clicking on the “TAKE PRACTICE QUIZ” and “TAKE PRACTICE TEST” links in weeks 2, 4, and 6. The actual quizzes and tests may be administered by an external assessment system, wherein metadata in syllabus 516 specifies parameters for the assessment system, such as the subject matter to be tested, which may be stored in tool data 260, the number of questions, the difficulty, the allotted time period, the permitted reference materials, and other parameters. When week 2, 4, and 6 arrive during the class period, these links may be replaced by “TAKE QUIZ” and “TAKE MIDTERM”, allowing the student to take the actual quiz or test, which may cover the same subject matter but use a different set of problems from the corresponding practice quiz or test. After the quizzes and tests are evaluated and curved, the links may be replaced with “VIEW RESULTS”, allowing the student to review his testing performance.

The interactions with the learning objects linked in syllabus 516 are therefore enabled by the metadata for syllabus 516, which can also specify permissions according to various criteria. For example, only the students may be granted permission to take practice and actual tests, whereas the IDD team and the faculty are only granted permission to conduct read-only previews of quizzes and tests. Accordingly, when faculty are authoring the syllabus and decide to preview the syllabus as it would appear to students, the syllabus may appear similar to syllabus 516 in FIG. 5, but with the “TAKE PRACTICE QUIZ” and “TAKE PRACTICE TEST” links replaced with “PREVIEW QUIZ” and “PREVIEW TEST” links. Additionally, in the context of syllabus authoring, faculty members may be presented with additional user interface widgets to adjust the various parameters of the quizzes and tests, or to select the problems that may appear in the practice test versus the actual test. Thus, the metadata in syllabus 516 can specify permissions for viewing, editing, and interacting with the syllabus and its linked learning objects, depending on the workflow context of the syllabus and/or the role of the user accessing the syllabus.

Further, as discussed above, the metadata can track all changes and interactions with syllabus 516, regardless of the particular workflow context or user. Thus, the impact of each change or set of changes to syllabus 516 can be readily ascertained, and these impacts may be noted in student database 126 and/or learning activity repository 146, for example by modifying the activity ratings in learning activity repository 146, thereby providing valuable insight for authoring more effective syllabi in the future. Additionally, the metadata can also enable data mining for analytics, computational logic, provisioning, and other tasks.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and subject-verb agreement selections to processor 604. Another type of user input device is cursor control 616, such as a mouse, a trackball, or cursor direction keys for communicating direction information and subject-verb agreement selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
selecting a particular objective from one or more objectives defined in a syllabus for a particular course offering;
retrieving, from an activity repository, a candidate activity for teaching the particular objective, wherein the candidate activity has a rating that is higher than an existing activity in the syllabus for teaching the particular objective; and
performing at least one of:
displaying the candidate activity in a user interface and providing a control in the user interface to replace the existing activity in the syllabus with the candidate activity; or
replacing the existing activity in the syllabus with the candidate activity automatically;
wherein the method is performed by one or more computing devices.

2. The method of claim 1, wherein the rating of the candidate activity is based on at least one of:
a student profile service assessing historical student performance in relation to the candidate activity; and
a student career service assessing a professional relevance of the candidate activity.

3. The method of claim 1, further comprising, prior to said performing:
determining, based on current research, that a new activity has a higher rating than the candidate activity;
adding the new activity to the activity repository; and
replacing the candidate activity with the new activity.

4. The method of claim 3, wherein said determining uses a search engine that rates the new activity based on at least one of:
the new activity is more recently established;
the new activity has a higher popularity or a greater number of citations;
the new activity is endorsed by a noted expert; and
the new activity is highly relevant for an academic or professional community.

5. The method of claim 1, further comprising:
adding metadata in the syllabus that associates the candidate activity in the syllabus to a corresponding activity in the activity repository and to one or more learning objects in tool data.

6. The method of claim 1, further comprising:
adding metadata in the syllabus that tracks the replacing of the existing activity in the syllabus with the candidate activity.

7. The method of claim 6, further comprising:
modifying the rating of the existing activity or the rating of the candidate activity in the activity repository based on the metadata.

8. A method comprising:
populating a syllabus for a particular course offering with course activities by executing, for each objective of one or more objectives defined in the syllabus:
retrieving, from an activity repository, a candidate activity for teaching said each objective, said retrieving based on a rating of the candidate activity for teaching said each objective; and
performing at least one of:
displaying the candidate activity in a user interface and providing a control in the user interface to add the candidate activity into the course activities of the syllabus; or
adding the candidate activity to the course activities of the syllabus automatically;
wherein the method is performed by one or more computing devices.

9. The method of claim 8, further comprising, prior to said performing:
determining, based on current research, that a new activity has a higher rating than the candidate activity;
adding the new activity to the activity repository; and
replacing the candidate activity with the new activity.

10. The method of claim 9, wherein said determining uses a search engine that rates the new activity based on at least one of:
the new activity is more recently established;
the new activity has a higher popularity or a greater number of citations;
the new activity is endorsed by a noted expert; and
the new activity is highly relevant for an academic or professional community.

11. The method of claim 8, further comprising:
determining a list of additional objectives to meet one or more accreditation agency requirements that are not satisfied by the syllabus;
appending the additional objectives to the one or more objectives defined in the syllabus; and
repeating said populating for each of the additional objectives.

12. The method of claim 8, wherein the rating of the candidate activity is based on at least one of:
a student profile service assessing historical student performance in relation to the candidate activity; and
a student career service assessing a professional relevance of the candidate activity.

13. The method of claim 8, further comprising:
adding metadata into the syllabus that specifies one or more user role or workflow context based permissions for interacting with the syllabus.

14. The method of claim 8, further comprising:
adding metadata that associates the course activities with corresponding activities in the activity repository and one or more learning objects in tool data.

15. The method of claim 14, further comprising:
presenting the syllabus on a graphical user interface that provides links to interact with the learning objects.

16. A non-transitory computer-readable medium storing one or more sequences of instructions which, when executed by one or more processors, cause performing of:
selecting a particular objective from one or more objectives defined in a syllabus for a particular course offering;
retrieving, from an activity repository, a candidate activity for teaching the particular objective, wherein the candidate activity has a rating that is higher than an existing activity in the syllabus for teaching the particular objective; and
carrying out at least one of:
displaying the candidate activity in a user interface and providing a control in the user interface to replace the existing activity in the syllabus with the candidate activity; or
replacing the existing activity in the syllabus with the candidate activity automatically.

17. The non-transitory computer-readable medium of claim 16, wherein the rating of the candidate activity is based on at least one of:
a student profile service assessing historical student performance in relation to the candidate activity; and
a student career service assessing a professional relevance of the candidate activity.

18. The non-transitory computer-readable medium of claim 16, wherein the one or more sequences of instructions further cause performing of, prior to said carrying out:
determining, based on current research, that a new activity has a higher rating than the candidate activity;
adding the new activity to the activity repository; and
replacing the candidate activity with the new activity.

19. The non-transitory computer-readable medium of claim 18, wherein said determining uses a search engine that rates the new activity based on at least one of:
the new activity is more recently established;
the new activity has a higher popularity or a greater number of citations;
the new activity is endorsed by a noted expert; and
the new activity is highly relevant for an academic or professional community.

20. The non-transitory computer-readable medium of claim 16, wherein the one or more sequences of instructions further cause performing of:
adding metadata in the syllabus that associates the candidate activity in the syllabus to a corresponding activity in the activity repository and to one or more learning objects in tool data.
